(19) United States
(12) Patent Application Publication
(10) Pub. No.: US 2013/0232035 A1
(43) Pub. Date: Sep. 5, 2013

(54) SYSTEM AND METHOD FOR PROVIDING INTEGRATED ELECTRONIC COMMERCE MARKETPLACE AND SETTLEMENT FUNCTIONALITY

(71) Applicant: MASTERCARD INTERNATIONAL INCORPORATED, Purchase, NY (US)

(72) Inventors: Rene A.A. STIJEN, Leuven (BE); Steven Robert SHIRLEY, Coventry (GB)

(73) Assignee: MasterCard International Incorporated, Purchase, NY (US)

(21) Appl. No.: 13/785,318

(22) Filed: Mar. 5, 2013

Related U.S. Application Data
(60) Provisional application No. 61/606,831, filed on Mar. 5, 2012.

(51) Int. Cl. G06Q 30/06

(52) U.S. Cl. CPC G06Q 30/0635
USPC 705/26.81

(57) ABSTRACT

A method for facilitating a market transaction includes: storing, in a database, a plurality of quote data entries, wherein each quote data entry includes data related to a supplier quote for goods or services and is associated with a supplier; receiving, by a receiving device, a purchase order for goods or services, wherein the purchase order identifies a supplier; transmitting, by a transmitting device, the purchase order to the supplier identified in the purchase order; receiving, by the receiving device, an invoice corresponding to the purchase order; identifying, by a processing device, a virtual payment number; and transmitting, by the transmitting device, the virtual payment number to the supplier for funding of a financial transaction based on the invoice.

### RELATED APPLICATION

This applications claims the priority benefit of commonly assigned U.S. Provisional Application No. 61/606,831, filed on Mar. 5, 2012, for “System and Method for Providing Integrated Electronic Commerce Marketplace and Settlement Functionality,” by Rene Stijen et al.

### FIELD

The present disclosure relates to methods and systems for providing integrated electronic commerce marketplace and settlement functionality, specifically increasing the efficiency throughout the supply chain by integrating an electronic commerce marketplace with a payment card processing network.

### BACKGROUND

As the electronic commerce market develops, both buyers and sellers face increased financial pressure to reduce costs, to improve cash flow, and to manage working capital more efficiently. Entities in the market strive to simplify inefficient practices, to maximize return on investment, and to adapt to increasing resource constraints. Traditional marketplace systems offer different services and solutions in a largely competitive environment. As a result, it is both difficult and costly for buyers to configure the best combination of services. This can in turn discourage and disenfranchise suppliers by having to cope with multiple buyer platforms.

Thus, there is a perceived opportunity to improve the electronic commerce market by integrating the market with settlement functionality as to provide a more efficient, adaptive system.

### SUMMARY

The present disclosure provides for a system and method for processing an electronic commerce market transaction.

A method for facilitating a market transaction includes: storing, in a database, a plurality of quote data entries, wherein each quote data entry includes data related to a supplier quote for goods or services and is associated with a supplier; receiving, by a receiving device, a purchase order for goods or services, wherein the purchase order identifies a supplier; transmitting, by a transmitting device, the purchase order to the supplier identified in the purchase order; receiving, by the receiving device, an invoice corresponding to the purchase order; identifying, by a processing device, a virtual payment number; and transmitting, by the transmitting device, the virtual payment number to the supplier for funding of a financial transaction based on the invoice.

A system for facilitating a market transaction includes a processing device, a database, a receiving device, and a transmitting device. The database is configured to store a plurality of quote data entries, wherein each quote data entry includes data related to a supplier quote for goods or services and is associated with a supplier. The receiving device is configured to receive a purchase order for goods or services, wherein the purchase order identifies a supplier. The transmitting device is configured to transmit the purchase order to the supplier identified in the purchase order. The receiving device is further configured to receive an invoice corresponding to the purchase order. The processing device is configured to identify a virtual payment number. The transmitting device is further configured to transmit the virtual payment number to the supplier for funding of a financial transaction based on the invoice.

### BRIEF DESCRIPTION OF THE DRAWING FIGURES

Exemplary embodiments are best understood from the following detailed description when read in conjunction with the accompanying drawings. Included in the drawings are the following figures:

FIG. 1 is a flow diagram illustrating a method for processing an order for a market transaction in accordance with exemplary embodiments.

FIG. 2 is a flow diagram illustrating a method for processing payment in a market transaction in accordance with exemplary embodiments.

FIGS. 3A and 3B are a processing flow illustrating a method for the processing of a market transaction in accordance with exemplary embodiments.

FIGS. 4A, 4B, 5A, and 5B are process flows illustrating methods for providing integrated electronic commerce marketplace and settlement functionality in accordance with exemplary embodiments.

FIG. 6 is a flow chart illustrating an exemplary method for facilitating a market transaction in accordance with exemplary embodiments.

FIG. 7 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include gift cards, personalized gift cards, payment cards, letters of credit, checks, financial accounts, etc. Examples of networks or systems configured to perform as payment networks include those operated by MasterCard®, VISA®, Discover®, American Express®, etc.

Payment Account—A financial account that may be used to fund a transaction, such as a checking account, savings account, credit account, virtual payment account, etc. A payment account may be associated with an entity, which may include a person, family, company, corporation, governmental entity, etc. In some instances, a payment account may be virtual, such as those accounts operated by PayPal®, etc.

Payment Card—A card or data associated with a payment account that may be provided to a merchant in order to fund a financial transaction via the associated payment account. Payment cards may include credit cards, debit cards, charge cards, stored-value cards, prepaid cards, fleet cards, virtual payment numbers, virtual card numbers, controlled payment numbers, etc. A payment card may be a physical card that may be provided to a merchant, or may be data representing the associated payment account (e.g., as stored in a communication device, such as a smart phone or computer). For example, in some instances, data including a payment account number may be considered a payment card for the processing of a transaction funded by the associated payment account. In some instances, a check may be considered a payment card where applicable.

Virtual Payment Number—A virtual payment number (VPN) may be a payment number for use in funding a financial transaction. A VPN may be formatted and processed the same as a traditional payment card number, and in some instances may be mapped to a payment account for processing of financial transactions using the VPN. The corresponding financial transaction may then be processed on the payment account by use of the VPN instead of the standard payment account number. In some instances, a physical payment card may be issued for the VPN, such that the VPN may be used in a traditional payment card transaction at a merchant point-of-sale. The use of a VPN may allow issuers, payment networks, cardholders, etc. to place restrictions on the use of the VPN, such as configuring the VPN to be used for a single transaction, placing amount limits on transactions, limits on use frequency of the VPN, etc. The use of VPNs for processing payment card transactions is discussed in further detail in U.S. Pat. No. 6,636,833 entitled “Credit Card System and Method,” issued Oct. 21, 2003; U.S. Pat. No. 7,136,835 entitled “Credit Card System and Method,” issued Nov. 14, 2006; U.S. Pat. No. 7,567,934 entitled “Credit Card System and Method,” issued Jul. 28, 2009; U.S. Pat. No. 7,571,142 entitled “Credit Card System and Method,” issued Aug. 4, 2009; U.S. Pat. No. 7,593,896 entitled “Credit Card System and Method,” issued Sep. 22, 2009; U.S. patent application Ser. No. 12/219,952 entitled “Credit Cards System and Method Having Additional Features,” filed Jul. 30, 2008; U.S. patent application Ser. No. 12/268,063 entitled “Credit Card System and Method,” filed Nov. 10, 2008; and U.S. patent application Ser. No. 12/359,971 entitled “Credit Card System and Method,” filed Jan. 26, 2009, all of which are herein incorporated by reference in their entirety.

### Order Processing for a Market Transaction

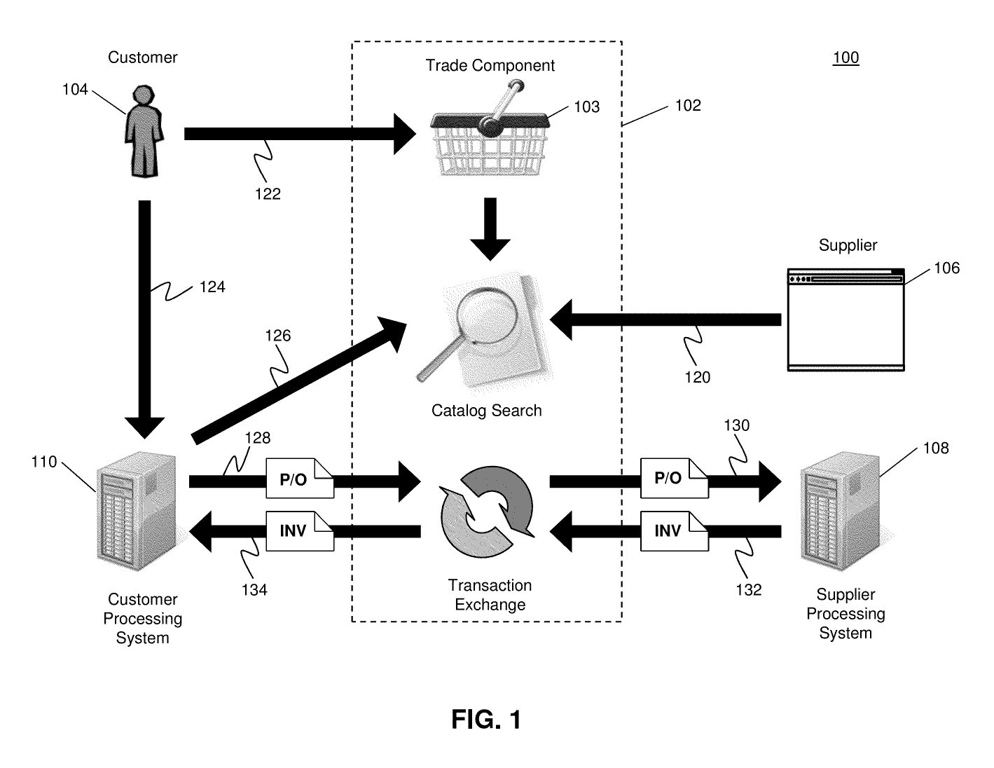

FIG. 1 is a flow diagram illustrating a method 100 for processing an order for a market transaction.

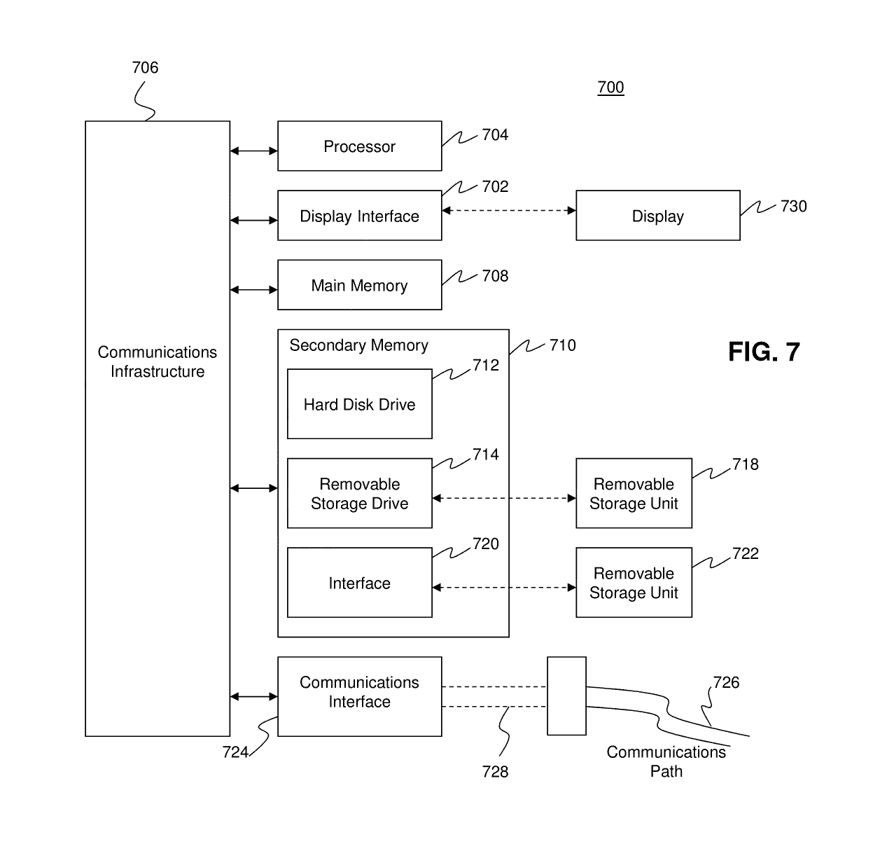

The method 100 may use a processing server 102, which may include a trade component 103. The processing server 102 and/or trade component 103 may be a computer system, such as the computer system 700 illustrated in FIG. 7 and described in more detail below. In some embodiments, the processing server 102 may be part of a payment network. In a further embodiment, the processing server 102 may be further configured to process financial transactions using methods and systems that will be apparent to persons having skill in the relevant art.

In step 120, a supplier 106 may provide a catalogue or quote (e.g., for a market transaction) to the processing server 102. The quote may be a quote for products, goods, or services, or any other quote as will be apparent to persons having skill in the relevant art. The processing server 102 may store the data supplied by the supplier 106 in a database. A customer 104 may login to the processing server 102 and/or to a customer processing system 110, in steps 122 and 124, respectively. The processing server 102 and/or the customer processing system 110 may be configured to store customer information, such as authentication information, account information, user preferences, etc. Methods of logging in or otherwise authenticating the identity of the customer 104 will be apparent to persons having skill in the relevant art. It will further be apparent to persons having skill in the relevant art that step 122 may be an optional step.

In step 126, the customer processing system 110 may access supplier content from the processing server 102. The supplier content accessed by the customer 104 may include the catalogue or quote provided by the supplier 106 in step 120 and stored in a database by the processing server 102. Upon accessing the supplier content, the customer 104 may, via the customer processing system 110, submit a purchase order to the processing server 102 in step 128. The purchase order may be an order for a market transaction for products, goods, services, etc., such as those provided for in the catalogue or quote provided by the supplier 106. In an exemplary embodiment, the purchase order may identify the supplier 106.

In step 130, the processing server 102 may provide the purchase order to a supplier processing system 108. The supplier processing system 108 may then generate an invoice based on the purchase order, which may be submitted to the processing server 102 in step 132. In some embodiments, the supplier 106 may cause the supplier processing system 108 to generate the invoice and/or may supply additional information or data for the generation of the invoice. In step 134, the processing server 102 may forward the invoice to the customer processing system 110, such as for viewing and/or storing by the customer 104.

### Payment Processing for a Market Transaction

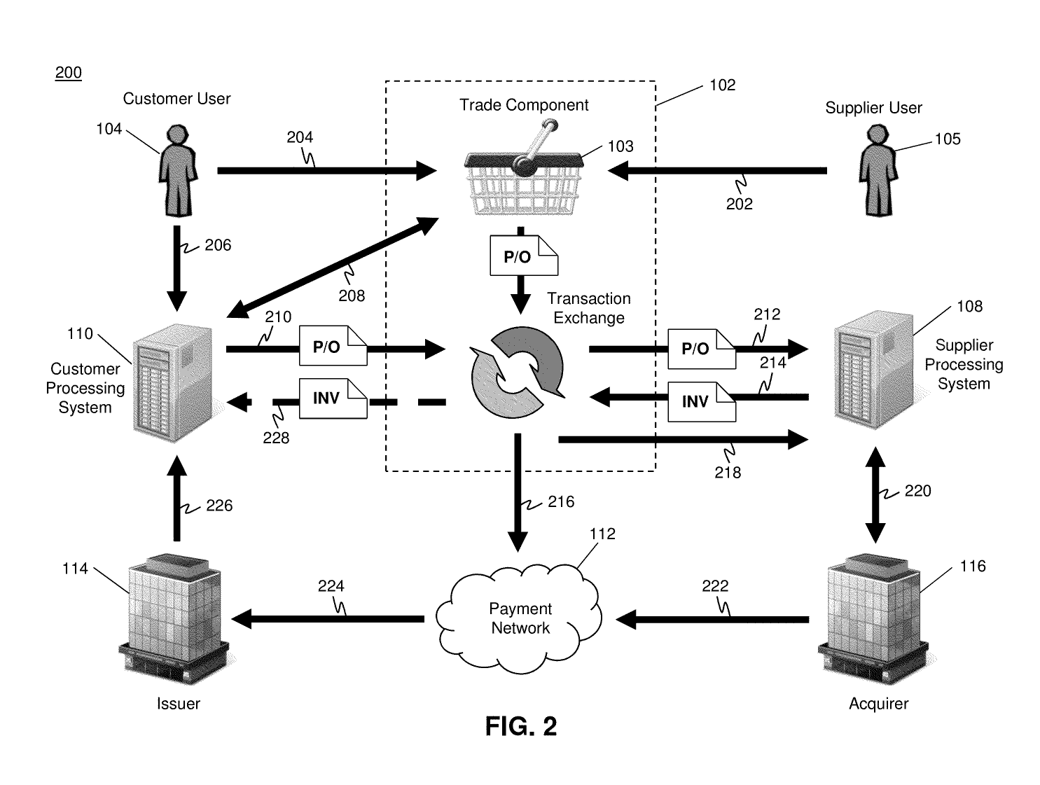

FIG. 2 is a flow diagram illustrating a method 200 for processing payment for a market transaction, such as a market transaction ordered using the method 100 of FIG. 1.

The method 200 may use the processing server 102, the customer processing system 110, and the supplier processing system 108, and may further include a payment network 112, an issuer 114, and an acquirer 116. In some embodiments, the processing server 102 may be part of the payment network 112 and/or be configured to perform the functions of the payment network 112 as discussed herein.

In step 202, a supplier 105 may provide a quote to the processing server 102 (e.g., to the trade component 103 of the processing server 102), which the processing server 102 may store in a database. In steps 204 and 206, the customer 104 may login (e.g., authenticate) with the processing server 102 and/or the customer processing system 110, respectively. In step 208, the customer 104 (e.g., via the customer processing system 110) may access supplier content from the processing server 102. The supplier content may include the quote submitted by the supplier 105 in step 202 and stored by the processing server 102.

In step 210, the customer 104 may submit a purchase order to the processing server 102 via the customer processing system 110. Information and data included in a purchase order will be apparent to persons having skill in the relevant art, but may include at least information identifying the supplier 105. In step 212, the processing server 102 may transmit the purchase order to the supplier processing system 108. The supplier processing system 108 may process the received purchase order and generate an invoice for the order (e.g., if the order is accepted by the supplier 105). The invoice for the order may be transmitted to the processing server 102 in step 214. The invoice may any information suitable for performing the functions herein, such as the purchase amount, fulfillment date, or any other additional information as will be apparent to persons having skill in the relevant art.

In step 216, the processing server 102 may submit an electronic payment authorization request to the payment network 112. The electronic payment authorization request may include at least the purchase amount as indicated in the invoice. The payment network 112 may respond to the electronic payment authorization request by providing, in step 218, a virtual payment number (VPN), which may be forwarded to the supplier processing system 108 by the processing server 102. In an exemplary embodiment, the VPN may be a one-time-use VPN. In a further embodiment, the VPN may only be authorized up to the purchase amount indicated in the invoice.

In step 220, the supplier processing system 108 may initiate a payment card transaction using the provided VPN. In an exemplary embodiment, the payment card transaction may be processed as a standard payment card transaction. The supplier processing system 108 may provide transaction details to the acquirer 116, which may be an acquiring bank or other entity that operates on behalf of the supplier 105 (e.g., for the processing of financial transactions). The acquirer 116 may provide an authorization request for the payment card transaction to the payment network 112. The authorization request may be formatted as pursuant to standardized format, such as the International Organization for Standardization ISO 8583 standard. The payment network 112 may clear (e.g., settle) the payment card transaction. Methods and systems for the processing and/or settlement of a payment card transaction will be apparent to persons having skill in the relevant art. In an exemplary embodiment, the payment network 112 may process the payment card transaction using a financial account mapped to the provided VPN.

In step 224, the payment network 112 may provide transaction details to the issuer 114. The issuer 114 may be an issuing bank or other entity that may operate on behalf of the customer 104 (e.g., by issuing a payment card or financial account to the customer 104, such as a financial account to which the VPN is mapped). In step 226, the issuer 114 may provide an electronic statement (e.g., reflecting the payment card transaction) to the customer processing system 110 (e.g., or directly to the customer 104). In one embodiment, the processing server 102 may also transmit the invoice to the customer processing system 110, as illustrated in step 228. It will be apparent to persons having skill in the relevant art that step 228 is an optional step.

### Market Transaction Processing Flow

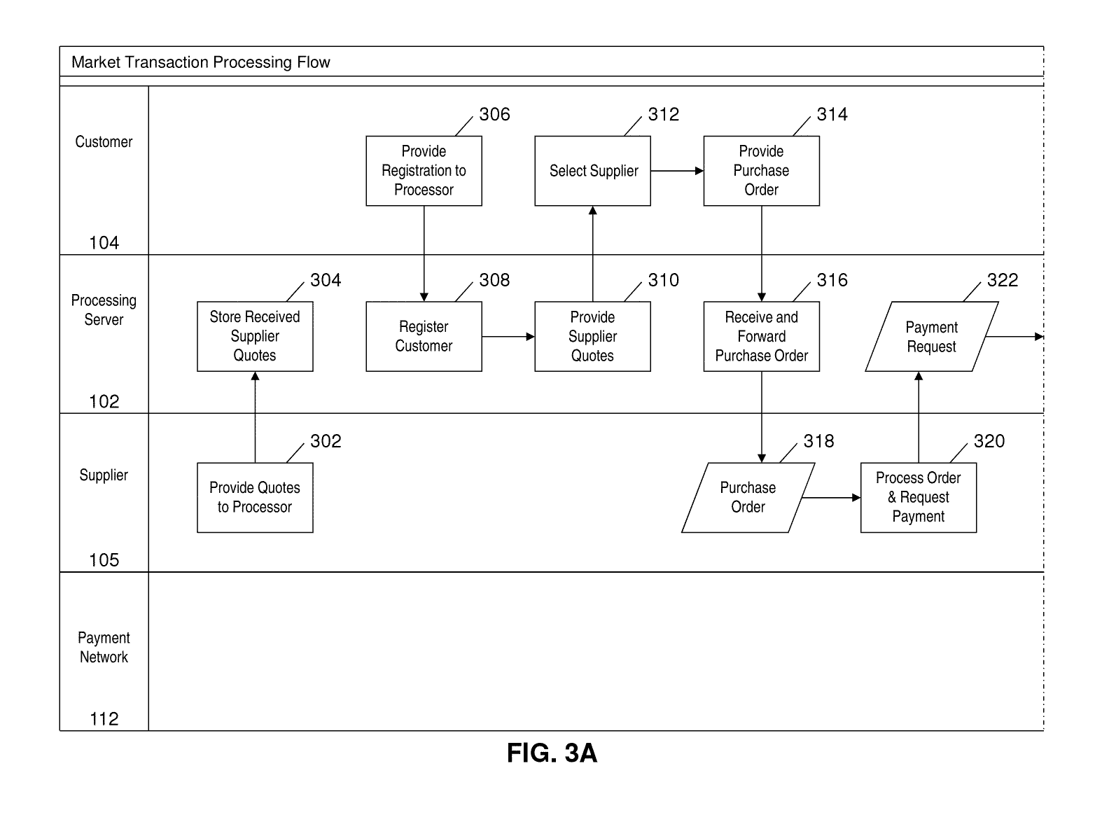

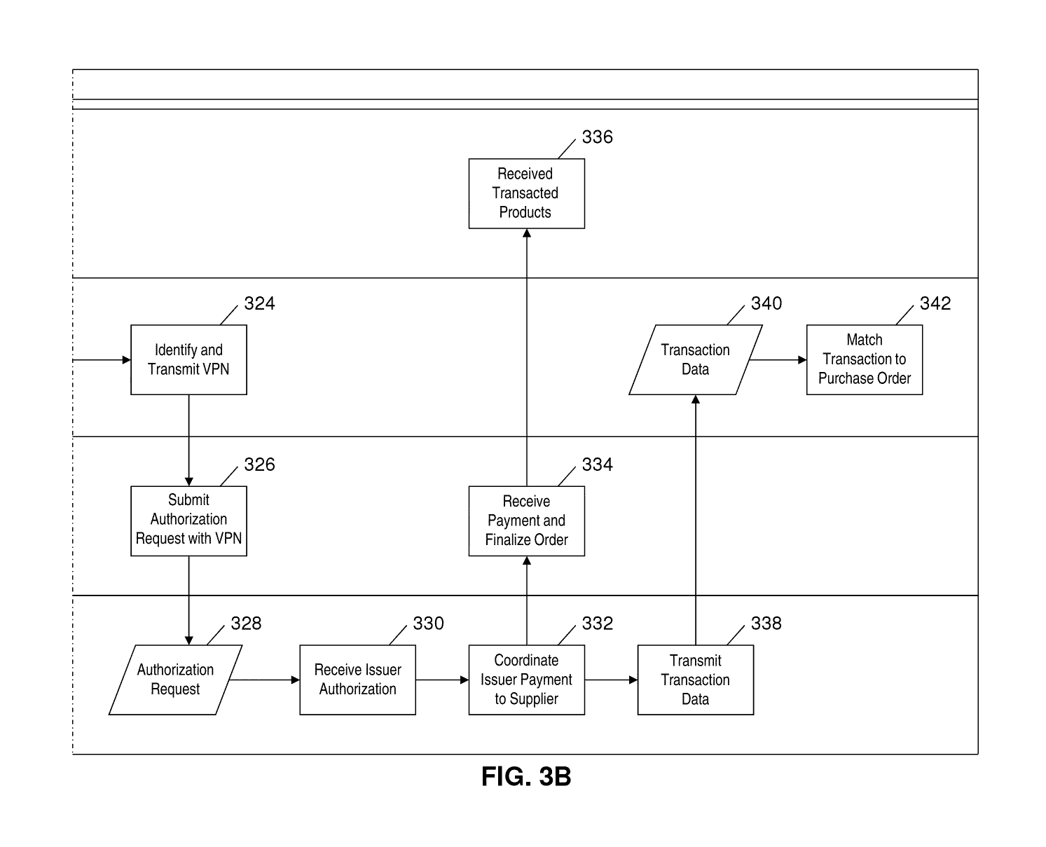

FIG. 3 is a processing flow illustrating a method for the processing of a market transaction in accordance with exemplary embodiments.

In step 302, the supplier 105 may provide quotes for goods or services to the processing server 102. In step 304, the processing server 102 may store the provided quotes in a database as quote data entries, wherein each quote data entry includes data related to the supplier quote and is associated with the supplier 105.

In step 306, the customer 104 may provide registration information to the processing server 102. The registration information may include identifying information (e.g., username, password, e-mail address, phone number, etc.), user preferences, contact information, financial account information (e.g., a payment account to which transactions will be charged), etc. In step 308, the processing server 102 may receive the information and may register the customer 104, such as by storing the customer information in a customer database. In step 310, the processing server 310 may provide supplier quotes to the customer 104.

In step 312, the customer 104 may select a supplier 105 based on the provided supplier quotes. Then, in step 314, the customer 104 may generate a purchase order for goods or services from the supplier 105 and provide the purchase order to the processing server 102. In an exemplary embodiment, the purchase order may identify the supplier 105. In step 316, the processing server 102 may receive the purchase order and may forward it on to the supplier 105, who may receive the purchase order in step 318.

In step 320, the supplier 105 may process the purchase order (e.g., by preparing the transacted for goods and services and/or fulfilling the order by providing goods or services to the customer 104) and may request payment from the processing server 102, such as by submitting an invoice. In step 322, the processing server 102 may receive the payment request (e.g., the invoice), which may include at least a purchase amount. In step 324, the processing server 102 may identify a virtual payment number (VPN) to be used for payment and may transmit the identified VPN to the supplier 105. In one embodiment, identifying the VPN may include communicating with the payment network 112 and/or the issuer 114 of a financial account associated with the customer 104 and receiving the VPN.

In step 326, the supplier 105 (e.g., or the acquirer 116 on behalf of the supplier 105) may submit an authorization request for a financial transaction for the purchase amount, the authorization request including the VPN as the payment method. In step 328, the payment network 112 may receive the authorization request. In step 330, the payment network 112 may communicate with the issuer 114 corresponding to the VPN, which may be identified as being associated with a payment account mapped to the VPN by the payment network 112 and/or the processing server 102. The issuer 114 may identify if the payment account has sufficient funds and/or credit available to approve the authorization request. In step 332, the payment network 112 may coordinate payment from the issuer 114 and/or the customer 104 to the supplier 105 and may submit an authorization response to the supplier 105 indicating approval of the financial transaction.

In step 334, the supplier 105 may receive the payment and may finalize the purchase order, such as by providing the transacted for goods and/or services to the customer 104. In step 336, the customer 102 may receive the transacted for products. It will be apparent to persons having skill in the relevant art that the customer 104 may receive the transacted for products at other points in the method, such as at step 320.

In step 338, the payment network 112 may transmit transaction data from the processed financial transaction to the processing server 102. Transaction data may include a transaction amount, the transaction time and/or date, an invoice number, a purchase order number, the VPN used for payment, etc. In step 342, the processing server 102 may match the financial transaction to the purchase order provided by the customer 104. Methods for matching the financial transaction to the purchase order will be apparent to persons having skill in the relevant art.

### Integrated Electronic Commerce Marketplace and Settlement Functionality

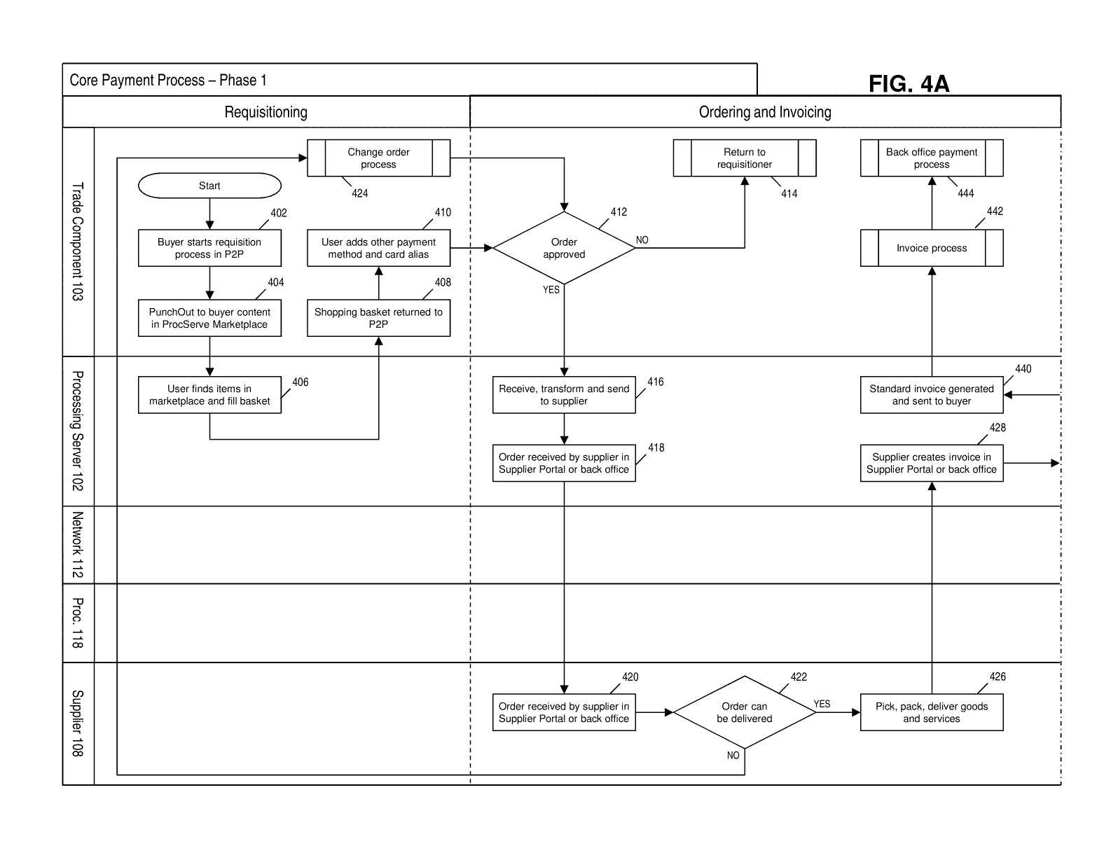

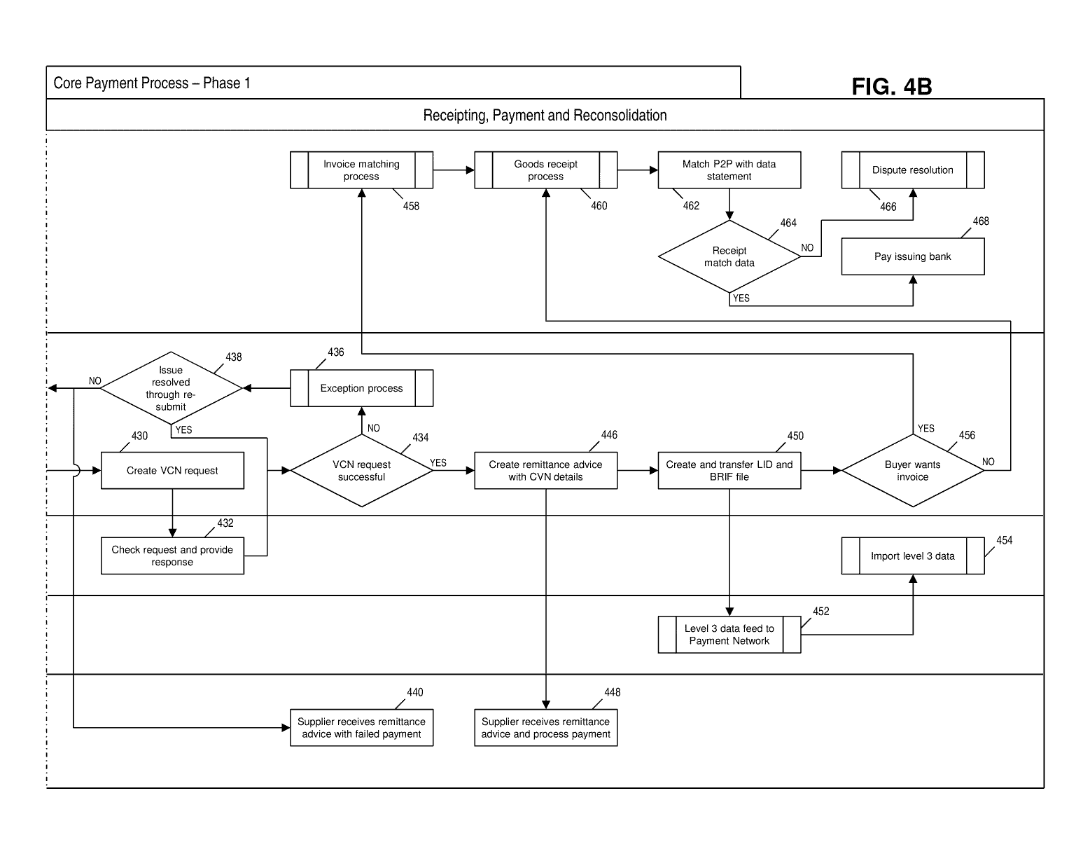

FIGS. 4A and 4B are a processing flow illustrating a first method for providing integrated electronic commerce marketplace and settlement functionality.

In step 402, a buyer (e.g., the customer 104) may start a requisition process using the trade component 103 (e.g., the purchase-to-pay component, or “P2P”), such as by providing authentication information. In one embodiment, the buy may start the process using a graphical user interface of the trade component 103, such as a website. In step 404, the authentication information may be transmitted to the processing server 102. In step 406, the processing server 102 may provide the buyer (e.g., via the trade component 103 or separate component) with a marketplace. The marketplace may include a plurality of goods or services (e.g., products) that the buyer may be able to purchase. The buyer may select products for purchase (e.g., using a virtual shopping cart), which may be transmitted to the trade component 103 in step 408. The trade component 103 may, in step 410, prompt the buyer for payment information. In one embodiment, the payment information may include financial account information. In another embodiment, the payment information may include payment card information.

In step 412, the trade component 103 may approve or deny the order. In one embodiment, the trade component 103 may approve or deny the order by attempting to process or by processing a financial transaction for the selected items using the payment information provided by the buyer. If the order is not approved, then, in step 414, the buyer may be returned to the requisitioning process. If the order was approved, then the processing server 102 may receive a purchase order for the purchase (e.g., for the items selected by the buyer) in step 416. In step 418, the purchase order may be transmitted to the supplier processing system 108.

In step 420, the supplier processing system 108 may receive the purchase order and may, in step 422, determine if the purchase order can be delivered (e.g., by the supplier 105). Methods of determining if a purchase order can be delivered (e.g., due to adequate inventory, time constraints, etc.) will be apparent to persons having skill in the relevant art. If the order can not be delivered, then, in step 424, the trade component 103 may change the order process. In one embodiment, the trade component 103 may notify the buyer and request modified order details. Modified order details may include, for example, a different supplier, different order date, different delivery date, different products, etc.

If the order can be delivered by the supplier 105 then, in step 426, the supplier processing system 108 may (e.g., via the supplier 105) deliver the goods or services to the buyer. The supplier processing system 108 may create an invoice for the purchase order that may be transmitted to and received by, in step 428, the processing server 102. The processing server 102 may then, in step 430, create a request for a virtual card number (VCN). In step 432, the request may be transmitted to the payment network 112, which may provide a response (e.g., a supplied VCN such as a one-time-use VCN) to the processing server 102.

In step 434, the processing server 102 may determine if the VCN request was successful. If the VCN request was unsuccessful (e.g., the payment network 112 denied the request for a VCN), then the processing server 102 may, in step 436, execute an exception process. In one embodiment, the exception process may include resubmitting the VCN request in step 438. If the resubmission is successful, then the process returns to step 434. If the resubmission was unsuccessful, then a standard invoice (e.g., the invoice received from the supplier processing system 108) may be generated and transmitted to the buyer in step 440. The invoice may be made available to the buyer by the trade component 103 (e.g., via the website) in step 442, and may initiate a traditional payment process (e.g., not using the supplied VCN) for the market transaction in step 444.

If the VCN request in step 434 was successful, then, in step 446, the processing server 102 may create remittance advice. The remittance advice may be advice on receiving payment for the market transaction and may include at least the VCN. The processing server 102 may transmit the remitting advice including the VCN to the supplier processing system 108, which may, in step 448, receive the advice and initiate a payment card transaction using the supplied VCN. In step 450, the processing server 102 may create and transfer transaction details and references files. The processing server 102 may transfer level 3 data to an external processing system 118 in step 452, which may in turn feed the level 3 data to the payment network 112 (e.g., for processing or matching the payment card transaction) in step 454. Data and information that may be included as level 3 data will be apparent to persons having skill in the relevant art.

In step 456, the processing server 102 may determine if the buyer requests an invoice for the transaction (e.g., by prompting the buyer, such as through the trade component 103 or via the website). If the buyer requests an invoice, then, in step 458, the trade component 103 may execute an invoice matching process. The invoice matching process may include matching the invoice to the purchase order previously supplied by the buyer. The invoice may be matched by using reference numbers, by other data included in the invoice, or by methods and processes as will be apparent to persons having skill in the relevant art.

After invoice matching, or if the processing server 102 determines that the buyer does not request an invoice, the trade component 103 may process the receipt of goods in step 460. Processing the receipt of goods may include an entity (e.g., the buyer, the supplier 105, or a third party) notifying the trade component 103 or processing server 102 of the fulfillment of the purchase order. In an exemplary embodiment, the receipt of goods may include the buyer notifying the trade component 103 (e.g., via the website) that the buyer received the ordered products. The receipt of goods may include information necessary for the authentication of the receipt, such as purchase amount, purchase date and time, etc. Other suitable information and methods for the receipt of goods will be apparent to persons having skill in the relevant art.

In step 462, the trade component 103 may match data include in the receipt of goods with previously obtained data, such as transaction detail data for the payment card transaction. In step 464, the trade component 103 may determine if the receipt data matches transaction data, such as to determine if the buyer's issuing bank was charged and paid for the ordered products and if the ordered products were received. If the data does not match, then, in step 466, the trade component may initiate a dispute resolution process. If the data does match, then, in step 468, the trade component may pay the issuing bank (e.g., using funds acquired in step 412 or as a result of the payment card transaction).

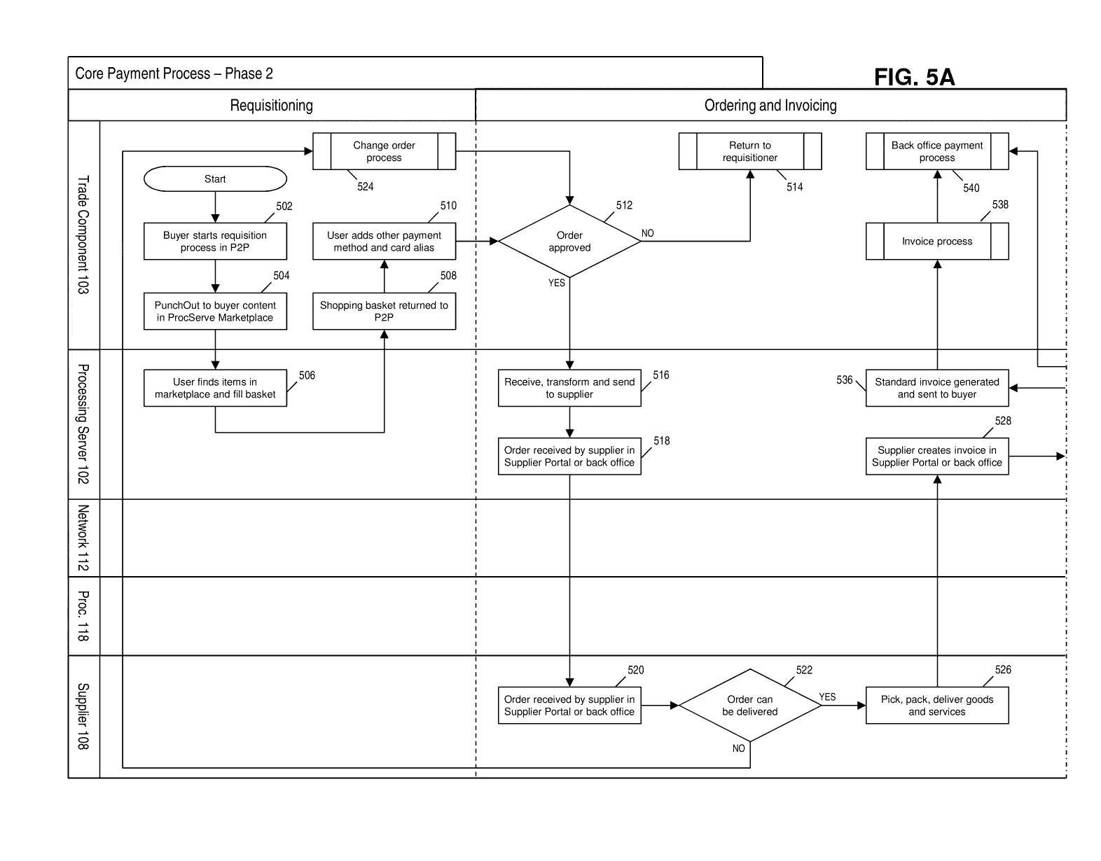

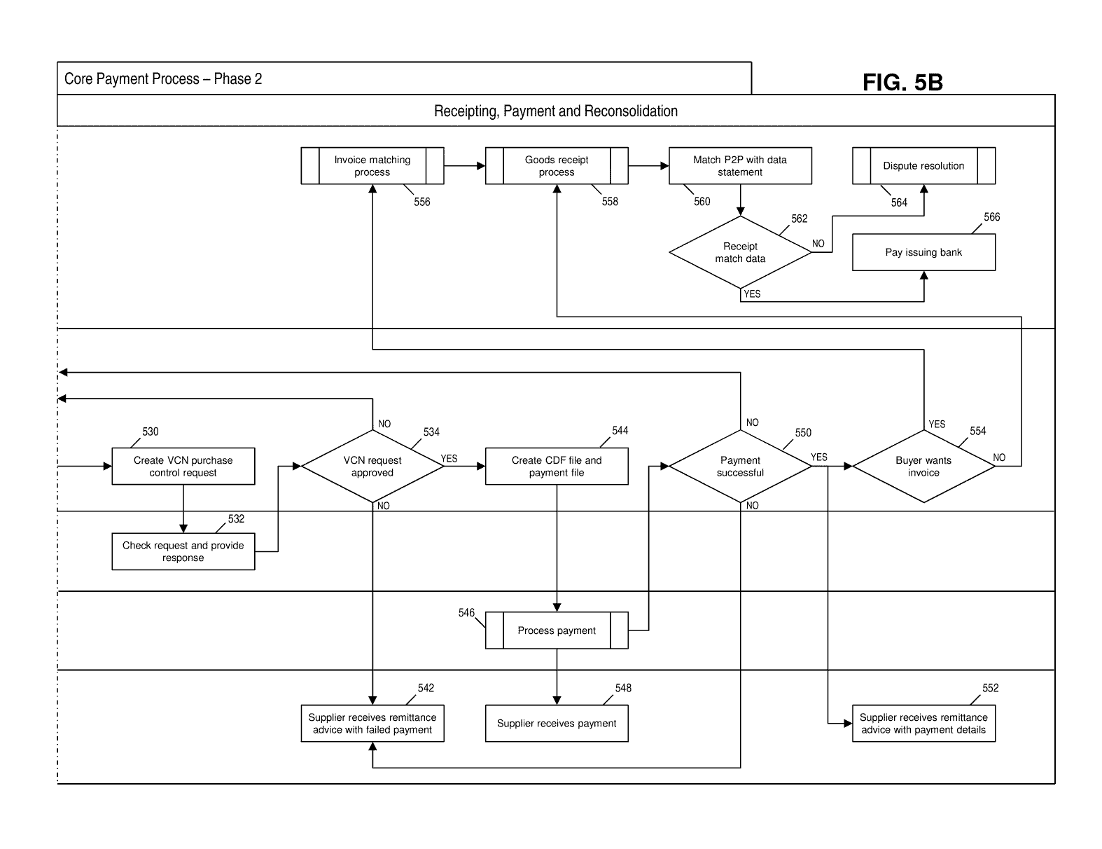

FIGS. 5A and 5B are a processing flow illustrating a second method for providing integrated electronic commerce marketplace and settlement functionality.

In step 502, a buyer (e.g., the customer 104) may start a requisition process using the trade component 103, such as by providing authentication information. In one embodiment, the buy may start the process using a graphical user interface of the trade component 103, such as a website. In step 504, the authentication information may be transmitted to the processing server 102. In step 506, the processing server 102 may provide the buyer (e.g., via the trade component 103 or separate component) with a marketplace. The marketplace may include a plurality of goods or services (e.g., products) that the buyer may be able to purchase. The buyer may select products for purchase (e.g., using a virtual shopping cart), which may be transmitted to the trade component 103 in step 508. The trade component 103 may, in step 510, prompt the buyer for payment information. In one embodiment, the payment information may include financial account information. In another embodiment, the payment information may include payment card information.

In step 512, the trade component 103 may approve or deny the order. In one embodiment, the trade component 103 may approve or deny the order by attempting to process or by processing a financial transaction for the selected items using the payment information provided by the buyer. If the order is not approved, then, in step 514, the buyer may be returned to the requisitioning process. If the order was approved, then the processing server 102 may receive a purchase order for the purchase (e.g., for the items selected by the buyer) in step 516. In step 518, the purchase order may be transmitted to the supplier processing system 108.

In step 520, the supplier processing system 108 may receive the purchase order and may, in step 522, determine if the purchase order can be delivered (e.g., by the supplier 105). Methods of determining if a purchase order can be delivered (e.g., due to adequate inventory, time constraints, etc.) will be apparent to persons having skill in the relevant art. If the order can not be delivered, then, in step 524, the trade component 103 may change the order process. In one embodiment, the trade component 103 may notify the buyer and request modified order details. Modified order details may include, for example, a different supplier, different order date, different delivery date, different products, etc.

If the order can be delivered by the supplier 105 then, in step 526, the supplier processing system 108 may (e.g., via the supplier 105) deliver the goods or services to the buyer. The supplier processing system 108 may create an invoice for the purchase order that may be transmitted to and received by, in step 528, the processing server 102. The processing server 102 may then, in step 530, create a request for a virtual card number (VCN). In step 532, the request may be transmitted to the payment network 112, which may provide a response (e.g., a supplied VCN such as a one-time-use VCN) to the processing server 102.

In step 534, the processing server 102 may determine if the VCN request was successful. If the VCN request was not successful (e.g., the payment network 112 denied the request), then a standard invoice (e.g., the invoice received from the supplier processing system 108) may be generated and transmitted to the buyer in step 536. The invoice may be made available to the buyer by the trade component 103 (e.g., via the website) in step 538, and may initiate a traditional payment process (e.g., not using the supplied VCN) for the market transaction in step 540. In addition, the processing server 102 may provide remittance advice stating the failed payment to the supplier processing system 108 in step 542.

If the VCN request was successful, then, in step 544, the processing server 102 may create a payment file. The payment file may include at least the VCN, and any other invoice or purchase order details for the processing of a payment card transaction as will be apparent to persons having skill in the relevant art. The payment file may be transmitted to the acquirer 116, who may then process a payment card transaction using the VCN in step 546. In step 548, the supplier 105 (e.g., via the supplier processing system 108) may receive payment for the purchase from the acquirer 116.

In step 550, the processing server 102 may determine if the payment was successful. If the payment was not successful, then the process may go to step 542 where the supplier processing system 108 may be notified of the failed payment, and to step 540 where a traditional payment process may be initiated. If the processing server 102 determines that payment was successful, then in step 554 the processing server may determine if the buyer requests an invoice (e.g., by prompting the buyer, such as through the trade component 103 or via the website). If the buyer requests an invoice, then, in step 556, the trade component 103 may execute an invoice matching process. The invoice matching process may include matching the invoice to the purchase order previously supplied by the buyer. The invoice may be matched by using reference numbers, by other data included in the invoice, or by methods and processes as will be apparent to persons having skill in the relevant art.

After invoice matching, or if the processing server 102 determines that the buyer does not request an invoice, the trade component 103 may process the receipt of goods in step 558. Processing the receipt of goods may include an entity (e.g., the buyer, the supplier 105, or a third party) notifying the trade component 103 or processing server 102 of the fulfillment of the purchase order. In an exemplary embodiment, the receipt of goods may include the buyer notifying the trade component 103 (e.g., via the website) that the buyer received the ordered products. The receipt of goods may include information necessary for the authentication of the receipt, such as purchase amount, purchase date and time, etc. Other suitable information and methods for the receipt of goods will be apparent to persons having skill in the relevant art.

In step 560, the trade component 103 may match data include in the receipt of goods with previously obtained data, such as transaction detail data for the payment card transaction. In step 562, the trade component 103 may determine if the receipt data matches transaction data, such as to determine if the buyer's issuing bank was charged and paid for the ordered products and if the ordered products were received. If the data does not match, then, in step 564, the trade component may initiate a dispute resolution process. If the data does match, then, in step 566, the trade component may pay the issuing bank (e.g., using funds acquired in step 512 or as a result of the payment card transaction).

### Exemplary Method for Facilitating a Market Transaction

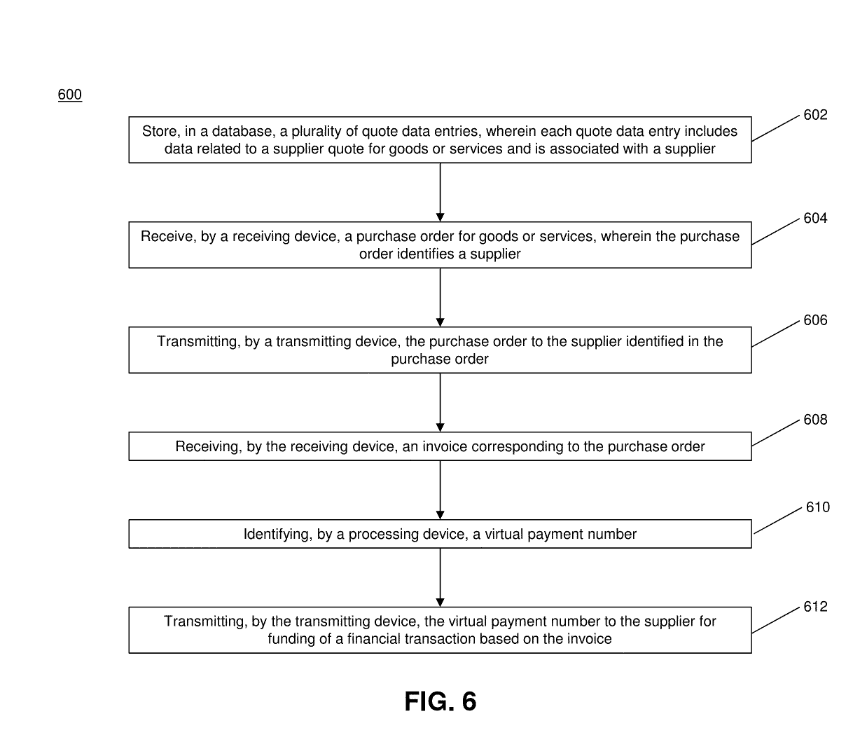

FIG. 6 illustrates a method 600 for facilitating a market transaction.

In step 602, a plurality of quote data entries are stored in a database, wherein each quote data entry includes data related to a supplier quote for goods or services and is associated with a supplier (e.g., the supplier 105). In step 604, a purchase order for goods or services may be received, by a receiving device, wherein the purchase order identifies a supplier 105. In step 606, the purchase order may be transmitted, by a transmitting device, to the supplier 105 identified in the purchase order. In one embodiment, the purchase order may identify a payment account.

In step 608, an invoice corresponding to the order may be received by the receiving device. In one embodiment, the invoice may include an estimated transaction amount. In step 610, a processing device may identify a virtual payment number (VPN). In one embodiment, the VPN may be a one-time use VPN. In embodiments where the invoice may include an estimated transaction amount, the VPN may be limited to a single financial transaction for the estimated transaction amount. In embodiments where the purchase order identifies a payment account, the VPN may be associated with the identified payment account. In step 612, the VPN may be transmitted, by the transmitting device, to the supplier 105 for funding of a financial transaction based on the invoice.

In one embodiment, the method 600 further includes: receiving an authorization request for the financial transaction, the authorization request including at least the VPN, processing the financial transaction, and transmitting an authorization response based on the processing of the financial transaction. In a further embodiment, the authorization request may be formatted pursuant to the ISO 8583 standard. In another further embodiment, the authorization request may further include a transaction amount, and processing the financial transaction may include processing payment from a financial account associated with the VPN for the transaction amount.

In another embodiment, the method 600 may further include receiving transaction data for the financial transaction, and mapping the received transaction data to the purchase order. In a further embodiment, the transaction data may include at least one of: a purchase order number, an invoice number, a transaction amount, a transaction time and/or date, a fulfillment time and/or date, product details, a supplier identifier, a customer identifier, and the VPN.

### Computer System Architecture

FIG. 7 illustrates a computer system 700 in which embodiments of the present disclosure, or portions thereof, may be implemented as computer-readable code. For example, the processing server 102, the supplier processing system 108, the customer processing system 110, the payment network 112, the issuer 114, and the acquirer 116 of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 1-6.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device. The processor device 704 may be connected to a communication infrastructure 706, such as a bus, message queue, network (e.g., the payment network 112), multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive, the removable storage unit 718 may be a floppy disk. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 624. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

Computer program medium and computer usable medium may refer to memories, such as the main memory 708 and secondary memory 710, which may be memory semiconductors (e.g. DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 1-6, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

Techniques consistent with the present disclosure provide, among other features, a system and method for facilitating market transactions. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for facilitating a market transaction, comprising:
storing, in a database, a plurality of quote data entries, wherein each quote data entry includes data related to a supplier quote for goods or services and is associated with a supplier;
receiving, by a receiving device, a purchase order for goods or services, wherein the purchase order identifies a supplier;
transmitting, by a transmitting device, the purchase order to the supplier identified in the purchase order;
receiving, by the receiving device, an invoice corresponding to the purchase order;
identifying, by a processing device, a virtual payment number; and
transmitting, by the transmitting device, the virtual payment number to the supplier for funding of a financial transaction based on the invoice;

2. The method of claim 1, further comprising:
receiving, by the receiving device, an authorization request for the financial transaction, wherein the authorization request includes at least the virtual payment number;
processing, by the processing device, the financial transaction; and
transmitting, by the transmitting device, an authorization response based on the processing of the financial transaction.

3. The method of claim 2, wherein the authorization request is formatted pursuant the ISO 8583 standard.

4. The method of claim 2, wherein the authorization request further includes at least a transaction amount, and wherein processing the financial transaction includes processing payment from a financial account associated with the virtual payment number for the transaction amount.

5. The method of claim 1, further comprising:
receiving, by the receiving device, transaction data for the financial transaction; and
mapping the received transaction data to the purchase order.

6. The method of claim 5, wherein the transaction data includes at least one of: a purchase order number, an invoice number, a transaction amount, a transaction time and/or date, a fulfillment time and/or date, product details, a supplier identifier, a customer identifier, and the virtual payment number.

7. The method of claim 1, wherein the virtual payment number is a one-time use virtual payment number.

8. The method of claim 1, wherein the invoice includes an estimated transaction amount.

9. The method of claim 8, wherein the virtual payment number is limited to a single financial transaction for the estimated transaction amount.

10. The method of claim 1, wherein the purchase order identifies a payment account.

11. The method of claim 10, wherein the virtual payment number is associated with the payment account.

12. A system for facilitating a market transaction, comprising:
a processing device;
a database configured to store a plurality of quote data entries, wherein each quote data entry includes data related to a supplier quote for goods or services and is associated with a supplier;
a receiving device configured to receive a purchase order for goods or services, wherein the purchase order identifies a supplier; and
a transmitting device configured to transmit the purchase order to the supplier identified in the purchase order, wherein
the receiving device is further configured to receive an invoice corresponding to the purchase order,
the processing device is configured to identify a virtual payment number, and
the transmitting device is further configured to transmit the virtual payment number to the supplier for funding of a financial transaction based on the invoice.

13. The system of claim 12, wherein
the receiving device is further configured to receive an authorization request for the financial transaction, the authorization request including at least the virtual payment number,
the processing device is further configured to process the financial transaction, and
the transmitting device is further configured to transmit an authorization response based on the processing of the financial transaction.

14. The system of claim 13, wherein the authorization request is formatted pursuant the ISO 8583 standard.

15. The system of claim 13, wherein the authorization request further includes at least a transaction amount, and wherein processing the financial transaction includes processing payment from a financial account associated with the virtual payment number for the transaction amount.

16. The system of claim 12, wherein
the receiving device is further configured to receive transaction data for the financial transaction, and
the processing device is further configured to map the received transaction data to the purchase order.

17. The system of claim 16, wherein the transaction data includes at least one of: a purchase order number, an invoice number, a transaction amount, a transaction time and/or date, a fulfillment time and/or date, product details, a supplier identifier, a customer identifier, and the virtual payment number.

18. The system of claim 12, wherein the virtual payment number is a one-time use virtual payment number.

19. The system of claim 12, wherein the invoice includes an estimated transaction amount.

20. The system of claim 19, wherein the virtual payment number is limited to a single financial transaction for the estimated transaction amount.

21. The system of claim 12, wherein the purchase order identifies a payment account.

22. The system of claim 21, wherein the virtual payment number is associated with the payment account.
